(19) United States
(12) Patent Application Publication
(10) Pub. No.: US 2008/0235150 A1
(43) Pub. Date: Sep. 25, 2008

(54) MARKET ANALYTICS

(75) Inventors: Ori Lotan, Chicago, IL (US); Jacob P. Doornebos, Riverside, IL (US); Kurt Windeler, Chicago, IL (US); Bruce S. Dickman, Wheeling, IL (US)

Correspondence Address: BANNER & WITCOFF, LTD.,;ATTORNEYS FOR CLIENT NO. 006119, 10 SOUTH WACKER DRIVE, SUITE 3000, CHICAGO, IL, 60606, US

(73) Assignee: CHICAGO MERCANTILE EXCHANGE, Chicago, IL (US)

(21) Appl. No.: 11/689,291

(22) Filed: Mar. 21, 2007

(51) Int. Cl. G06Q 40/00

(52) U.S. Cl. 705/36 R

(57) ABSTRACT

Systems, devices, and methods for historical market analytics are disclosed. Regulatory investigators/analysts and people interested in analyzing markets and market trends may analyze archived market data for a particular historical timeframe in a plurality of levels. Examples of market analytics systems allow users to query archived data for a market of financial instruments. In response to a query, the market analytics system displays order information for a selected prior timeframe, including multiple levels of best bids/asks for a selected financial instrument. The historical market data may be displayed in a grid format to show how the displayed levels change over time during the timeframe.

### TECHNICAL FIELD OF THE INVENTION

Aspects of the disclosure relate to systems, device, and methods for use in connection with the trading of financial instruments. More particularly, aspects of the disclosure provide mechanisms for recreating, displaying, and replaying a financial market.

### DESCRIPTION OF THE RELATED ART

Institutions that administer transactions for financial instruments generate large amounts of market data. The market data may be related to filled orders for financial instruments, including options contracts, futures contracts, securities, etc. The market data provided in real time or may be packaged and archived for later processing. The market data may be stored in large archived data stores in a central location. The market data may be arranged as groupings organized by date and time. To obtain information for selected products, large archives of data must be queried to identify data of interest. The downloading and querying can be time-consuming and require vast amounts of processing clock cycles and other computing resources. Under traditional approaches, large amounts of market data cannot be adequately processed, thereby preventing many uses of the market data, such as for providing market oversight. Existing tools may provide periodic summary snapshots for the top of the market, but do not include any information related to depth of the market. Accordingly, any analysis may be limited.

Therefore, there exists a need for an advanced market data analytics systems, apparatuses, and methods that allow for the rapid processing, storage searching, and sorting of large amounts of data in a time sensitive manner.

### BRIEF SUMMARY OF THE INVENTION

By way of introduction, systems, apparatuses, and/or methods for use in connection with recreating, displaying and replaying a financial market are disclosed. The financial market data may include multiple levels of bid/offer or buy/sell orders in a market at a desired historical timeframe.

In one embodiment, a system is disclosed for providing historical market data in a plurality of levels. The system may include a data server storing market data files, a cache server for communicating data corresponding to the market data files, an application server for communicating formatted market information, and/or one or more user computers accessing the application server. The formatted market information may correspond to parameters of a query sent to the application server. Certain devices in the system may include one or more of memory, processor, input component, and/or output component.

Of course, the apparatuses, methods and systems disclosed herein may also include other additional elements, steps, computer-executable instructions, or computer-readable data structures. The foregoing summary is provided only by way of introduction. The features and advantages of the market analytics may be realized and obtained by the instrumentalities and combinations pointed out in the claims. Nothing in this section should be taken as a limitation on the claims. Additional features and advantages will be set forth in the description that follows, and in part will be obvious from the description, or may be learned by practice of the present invention. The details of these and other embodiments of the present invention are set forth in the accompanying drawings and the description below. Other features and advantages of the invention will be apparent from the description and drawings, and from the claims.

### BRIEF DESCRIPTION OF THE DRAWINGS

Examples of market analytics are described with reference to the accompanying drawings, in which components, features and integral parts that correspond to one another each have the same reference number, wherein:

FIG. 1 shows a computer system in accordance with aspects of the invention;

FIG. 2 shows an illustrative method for providing historical market data in accordance with aspects of the invention; and

FIG. 3 through FIG. 7 illustrate numerous embodiments of the formatted market information displayed on graphical user interfaces in accordance with aspects of the invention.

### DETAILED DESCRIPTION OF THE INVENTION

In accordance with numerous aspects of the disclosure, the system, device, and/or method may take physical form in certain parts and steps, embodiments of which will be described in detail in the following description and illustrated in the accompanying drawings that form a part hereof.

Systems, methods and apparatuses of market analytics may be achieved in many different forms, formats, and designs and should not be construed as limited to the exemplary embodiments set forth herein. Embodiments may take the form of one or more devices, systems, distributed networks, data processing systems, processes, electronic hardware, computer software, firmware, including object and/or source code, and/or combinations thereof. Embodiments may be stored on computer-readable media installed on, deployed by, resident on, invoked by and/or used by one or more data processors, controllers, computers, clients, servers, gateways, networks of computers, and/or any combinations thereof. The computers, servers, gateways, may have one or more controllers configured to execute instructions embodied as computer software.

An illustrative embodiment may include software stored and executed on one or more servers having electronic components configured to carry out instructions according to a computer program stored on a computer-readable storage medium, such as a memory, hard disk, CD-ROM, optical storage device, magnetic storage device and/or combinations thereof to provide analytics for archived market data. Files having desired data may be identified and retrieved from a central data store. The data may be identified as a particular product, product group, as well as a user defined timeframe for the product and or product grouping. The retrieved file may be processed to uncompress any compressed data and to create a searchable binary file. The binary file may be queried to extract data and the book for the market recreated for the user-defined timeframe.

To process a query, the system may first search a temporary storage area to identify the associated binary. That is the binary file may have been retrieved with a data file from a prior query. If the binary file is available, the query may be processed locally and with minimal or no further retrieval of files from the central data store. If the binary file is not identified in the temporary storage, the system may look for any corresponding zipped files, before requesting any further zipped files from the central data store. The data identified from the query is presented in a grid that allows for the display of multiple top levels of the market for the product or product grouping. In one embodiment in accordance with aspects of the invention, the grid shows the top 5 bids and offers for a futures contract for a selected timeframe. The grid may be color-coded to identify each of the top five bids and offers. In some embodiments, the grid may include a line for the most recent top five levels of the market during the timeframe as well as a line for each change in the market to the least recent activity in the market in the timeframe. Each line may include a single change over the previous line in the grid. The changes over the previous line may be identified or highlighted to allow a user to more easily identify the changes.

Users of the system may include, but are not limited to: (1) investigators (e.g., regulatory analysts, auditors, etc.); (2) products & services group (e.g., those responsible for developing new financial products/services and/or marketing new/existing products/services); and (3) other people (e.g., anyone interested in watching market trends/behavior or in performing a technical analysis of historical market patterns.)

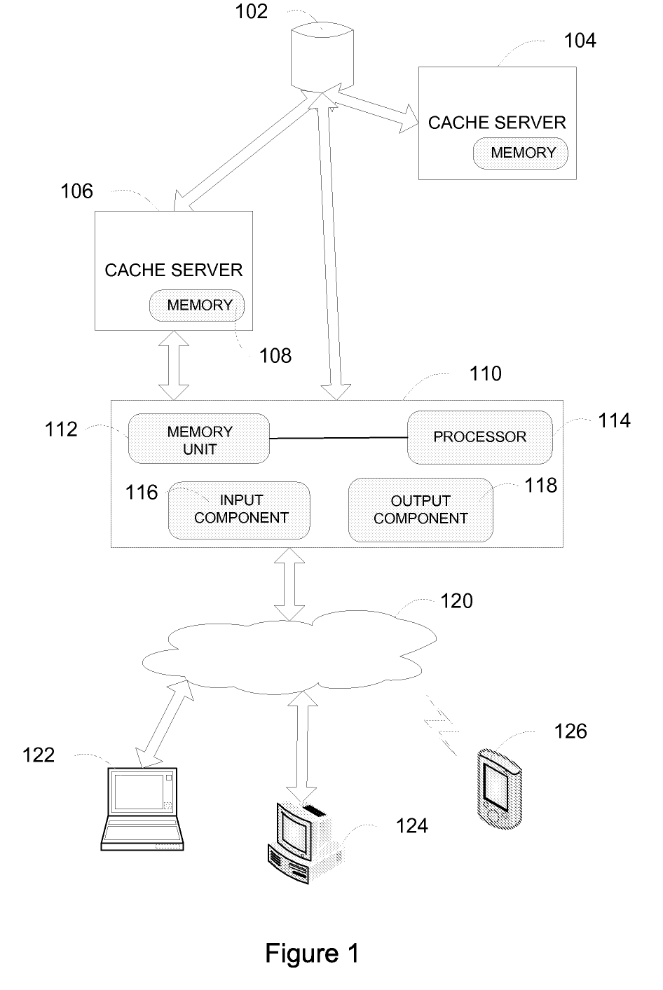

Aspects of the disclosure may be implemented with electronic computing devices, methods, systems and/or computer networks configured for exchanging trading information. An illustrative trading network environment for implementing a system in accordance with aspects of the invention is shown in FIG. 1.

In accordance with aspects of the invention, a data server 102 stores market data files. The data server 102 may be a SAN (storage area network) device or any other device that permits the storage and retrieval of large amounts of data. The data server 102 may contain or be connected with a memory with a large capacity. For example, in one embodiment the data server 102 may comprise an enterprise database where market data files are retrievable according to trading day. In another embodiment, the data server 102 may store market data files in accordance with aspects of the invention without the use of an enterprise database. Rather, in those embodiments, the market data files may be flat files (e.g., text files with comma-delimited values, text files with space-delimited values, computer files with data stored in a linear sequence, etc.) stored in memory associated with the data server 102. The market data files may be stored in a hierarchical structure (e.g., folders and subfolders, directories and subdirectories, etc.) based on trading date, trading time, product group, and/or any other parameter or combination of parameters.

Some examples of market data files include information identifying trades, descriptions of trades, and information identifying or associated with the time that a trade took place and the contract price, including, but not limited to the information contained in market data messages. One example of market data message formats is described in the Chicago Mercantile Exchange's “CME RLC Message Specification—Market Data Platform and MD API 2.x, version 3.1” (with a document release date of Nov. 20, 2006) documentation, which is publicly available for download from the CME's Internet website and herein incorporated by reference. Some examples of market data message types include MA, MY, M0, M5, M6, and other administrative, book, and pricing messages. The data in the market data messages (e.g., MA, MY, M0, etc.) may be stored as flat files organized by product group, financial instrument identifier, trading date/time, and/or any other parameter or combination of parameters.

One or more cache servers 104, 106 may be in communication with the data server 102. A cache server 104, 106 may be configured to communicate data corresponding to the market data files in response to a request. A cache server 104, 106 may include an illustrative memory 108 (e.g., random access memory (RAM), hard disk drive, or other storage capabilities) for storing the data corresponding to the market data files received from the data server 102. A cache server 104, 106 may be used to provide more efficient access to archived/historical market data. A cache server 104, 106 in accordance with aspects of the invention may use one or more of the techniques disclosed herein or known to one of skill in the art to cache market data files. For example, the data may be stored in an uncompressed form in memory 108 of a cache server 106 and the data may be stored in a compressed form (e.g., using a file compression tool such as those that result in a file with a .zip extension, and others) with the data server 102.

In one embodiment, the data server 102 and a cache server 104, 106 may communicate using the well-known file transfer protocol (FTP). One of skill in the art will appreciate that many other communication protocols exist in the art and could be implemented in accordance with aspects of the invention. One of skill in the art will also recognize that a cache server 104, 106 may be optional in one or more embodiments in accordance with the invention. In such embodiments, the data server 102 may communicate directly (i.e., without an intermediate cache server) with an application server 110.

An application server 110 may communicate with at least one cache server 106, 108 to request data corresponding to historical market data (e.g., stored in a market data file). In an alternative embodiment, as explained above, the application server 110 may communicate with the data server 102 to request data corresponding to market data files. The application server 110 may be configured to communicate formatted market information in response to a received query, and to process the query to generate a request for data corresponding to historical market data.

The application server 110 may be comprised of an input component 116 configured to receive queries. Examples of an input component in accordance with aspects of the invention include, but are not limited to, a keyboard (with a keypad), a mouse device, a touchscreen device, pointing device, microphone, pen device, voice recognition system, gestural recognition device, optical recognition, biometric recognition system, artificial intelligence, network communications unit, and other means for receiving data either currently known or later developed.

Furthermore, the application server 110 may comprise an output component 118 configured to output formatted market information. Examples of an output component in accordance with aspects of the invention include, but are not limited to, a viewable display screen (such as a computer monitor with a graphical user interface), printer, a network communications unit, and other means for sending data. One skilled in the art will appreciate that although FIG. 1 depicts an input component 116 and an output component 118 as two separate and distinct components, in some embodiments, they may be located in the same physical component or circuitry. For example, the input component and output component may be located in a network communications unit.

Furthermore, the application server 110 may comprise memory (i.e., memory unit 112) for storing, among other things, computer-readable instructions for execution by a processor 114 (e.g., a 64-bit microprocessor). When executed by a processor 114, the computer-readable instructions may cause the application server 110 to perform steps of a method in accordance with aspects of the invention. Details regarding the performed methods are discussed in detail throughout the disclosure.

A plurality of user computers 122, 124, 126 may be in communication with the application server. The plurality of user computers 122, 124, 126 may include an input component for receiving parameters relating to the query and a graphical user interface for rendering formatted market information. The user computers 122, 124, 126 may communicate through a network 102 (e.g., the Internet, a local area network (LAN), wide area network (WAN), or other telecommunications network). For example, a wireless personal digital assistant device (PDA) 126 may communicate with a network 120 via radio waves. PDA 126 may also communicate with the application server 110 via a conventional wireless hub. As used herein, a PDA includes mobile telephones and other wireless devices that communicate with a network via radio waves. Moreover, the topology shown in FIG. 1 is merely an example and that the components shown in FIG. 1 may be connected by numerous alternative topologies.

The query received at the application server 110 may be received through the input component 116 of the application server 110. In one embodiment in accordance with aspects of the invention, the input component 116 (or user input device) may comprise a keypad (e.g., a keypad on a keyboard, keypad on a touchscreen, etc.). A user may utilize the keypad to enter the parameters of a query. In another embodiment, the input component 116 may be located in a network communications unit, such as a network interface card (NIC) or other wired/wireless communications circuitry. In such an embodiment, the query may be sent from a remote computing device (e.g., a laptop 122, personal computer 124, or handheld computing device 126) through a network 120 and received at the application server 110 through the input component 116. The query may be included in an HTTP request or other communications format.

The query may be comprised of one or more parameters identifying the desired historical market data. For example, the parameters relating to the query may include a historical timeframe and a financial instrument identifier. The parameters relating to the query may further include a query type. The historical timeframe may include a data and a time range. For example, a user may provide a historical timeframe of Mar. 1, 2002 from 10 a.m. to 10:30 a.m. to query the corresponding historical market data. Examples of financial instrument identifier include the few-digit identifiers that correspond to financial products such as the CME S&P 500 OPTIONS, CME RUSS 2000 OPTIONS, CME NASDAQ 100 OPTIONS, CME U.S. SNOWFALL OPTS, CME HOUSING OPTIONS, CME S&P GROWTH FUT, and CME LEAN HOGS FUT. For example, “GEM7” is a financial instrument identifier. Another example of a financial instrument identifier in accordance with aspects of the invention is a future or options contract code including the applicable expiration month and year. Examples of query type include, but are not limited to, best limit, best implied, best price, best price and limit, best limit and implied, trade, and time & sales. Other examples of query type include liquidity analysis and trade analysis. One skilled in the art will appreciate that other query types are contemplated in accordance with aspects of the disclosure.

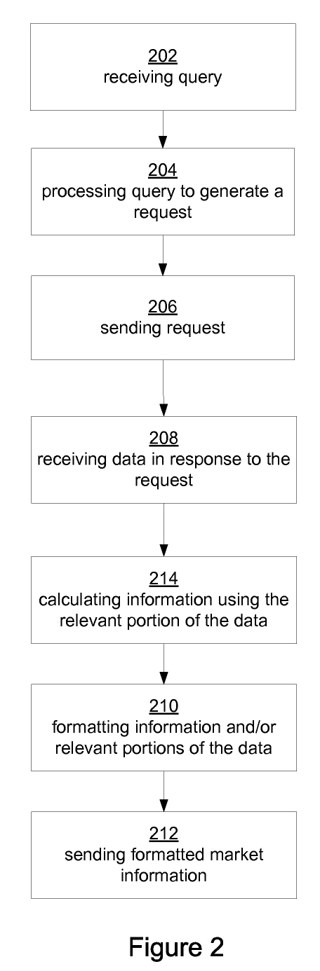

FIG. 2 shows an illustrative method for providing historical market data in accordance with aspects of the invention. In step 202, a computing device receives a query through an input component. The query may comprise a historical date, a time range, and a financial instrument identifier. In some embodiments, the query may further comprise a query type. In step 204, the computing device processes the query to generate a request for data corresponding to a market data file. Data corresponding to the market data file (i.e., historical market data) may be stored in a data server 102 or cache server 106. The computing device sends the request for the data in step 206. In one embodiment in accordance with aspects of the invention, a cgi (i.e., common gateway interface) script may run a search (i.e., request) for data in step 206. The cgi script may first search the cache server 106 for the data, and then search the data server 102 if the data is unavailable at the cache server. One skilled in the art will appreciate after review of the entirety disclosed herein that at least one advantage of the aforementioned aspects is a quicker response time to requests.

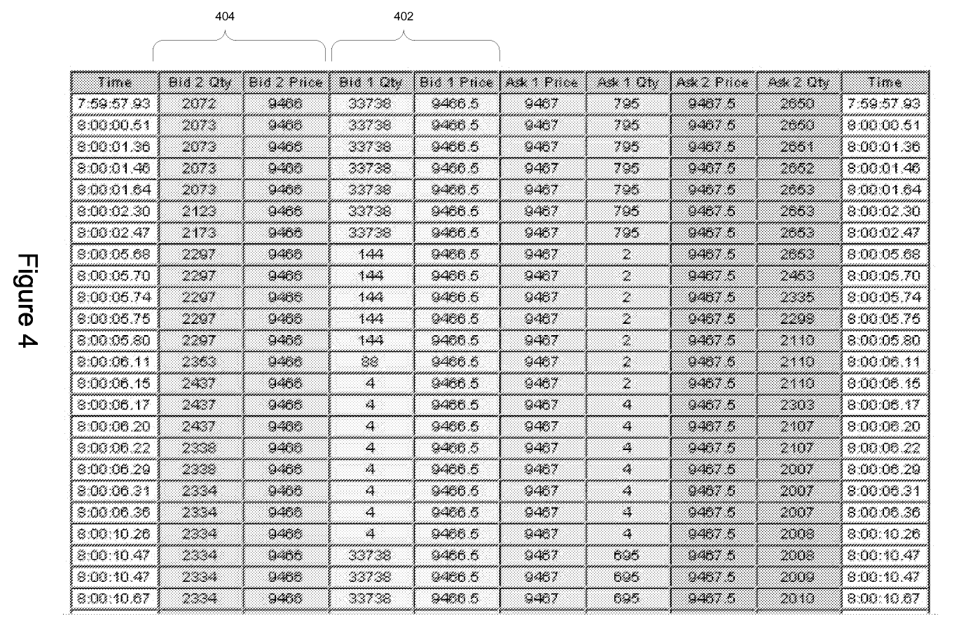

In response to sending the request, in step 208, receives data corresponding to the historical market data. In step 210, the computing device formats relevant portions of the data according to a query type to generate formatted market information. In some embodiments in accordance with aspects of the invention, the formatted market information may comprise a plurality of bid prices, bid quantities, ask prices, and ask quantities for the financial instrument identifier at a particular time occurring during the time range on the historical date. For example, in response to a query type of “best limits and implied,” relevant portions of data in market data message types MA and MY may be used to generate the formatted market information displayed in FIG. 4.

In step 212, the computing device may send the formatted market information to an output component.

In an alternative embodiment in accordance with aspects of the invention, in step 214, the computing device may calculate a plurality of spread information, bid difference information, and ask difference information associated with a financial instrument identifier using relevant portions of the data received in step 208. The spread information, bid difference information, and ask difference information may be time weighted average (or other techniques known in the art) over a predetermined interval (e.g., 1 minute). In step 210, the computing device may format the plurality of spread information, bid difference information, and ask difference information to generate formatted market information. The formatted market information comprising the plurality of spread information, bid difference information, and ask difference information for the financial instrument identifier at a particular time occurring during the historical timeframe.

Examples of formatted market information output by the application server 110 include historical market data that includes a plurality of levels for a particular financial instrument identifier. The particular financial instrument identifier may have been identified in a query received at the application server. In some embodiments in accordance with aspects of the invention, a financial instrument identifier may comprise at least one of: futures, contracts, options, bonds, securities commodities, annuities, and/or currencies. In one embodiment, the formatted market information may comprise a plurality of bid prices, bid quantities, ask prices, and ask quantities for a particular financial instrument identifier at a particular time occurring during a time range on a particular date. In another embodiment, the formatted market information may further include trade price and trade quantity for the financial instrument identifier. In yet another embodiment, the formatted market information may include a plurality of plurality of bid prices, bid quantities, bid order quantities, ask prices, ask quantities, and ask order quantities for a particular financial instrument identifier at a particular time occurring during a historical timeframe.

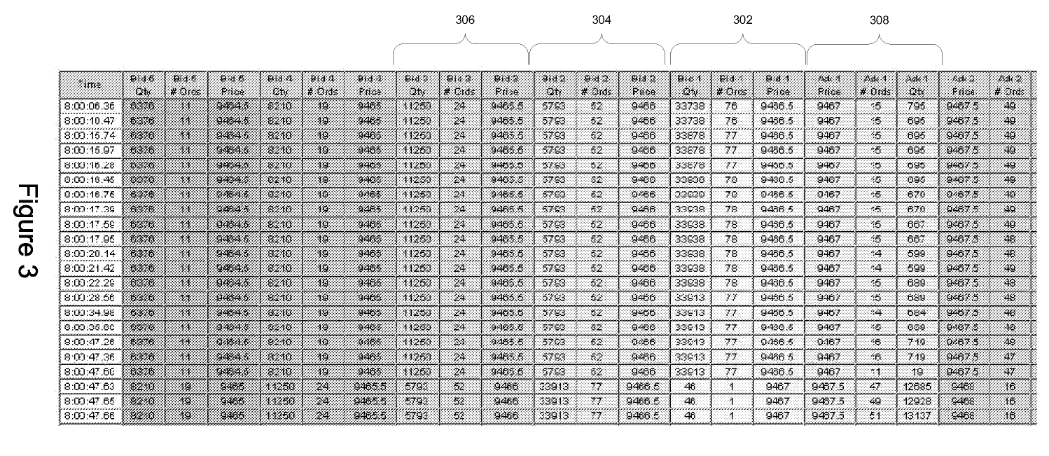

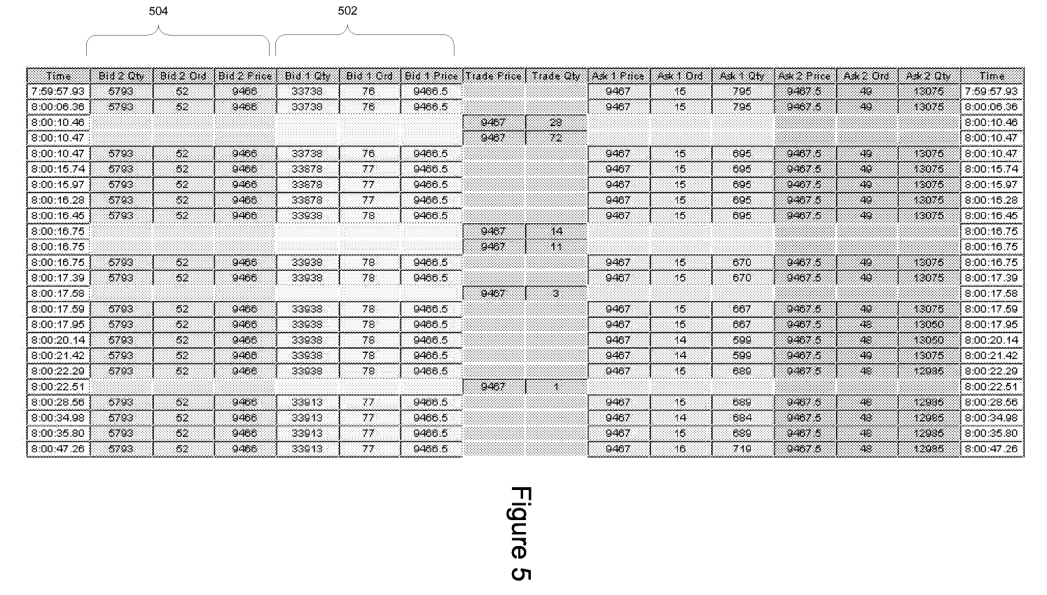

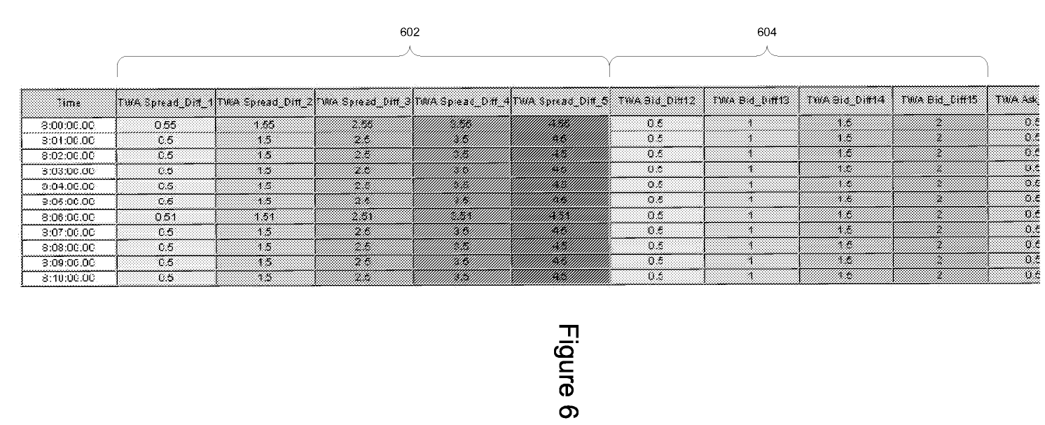

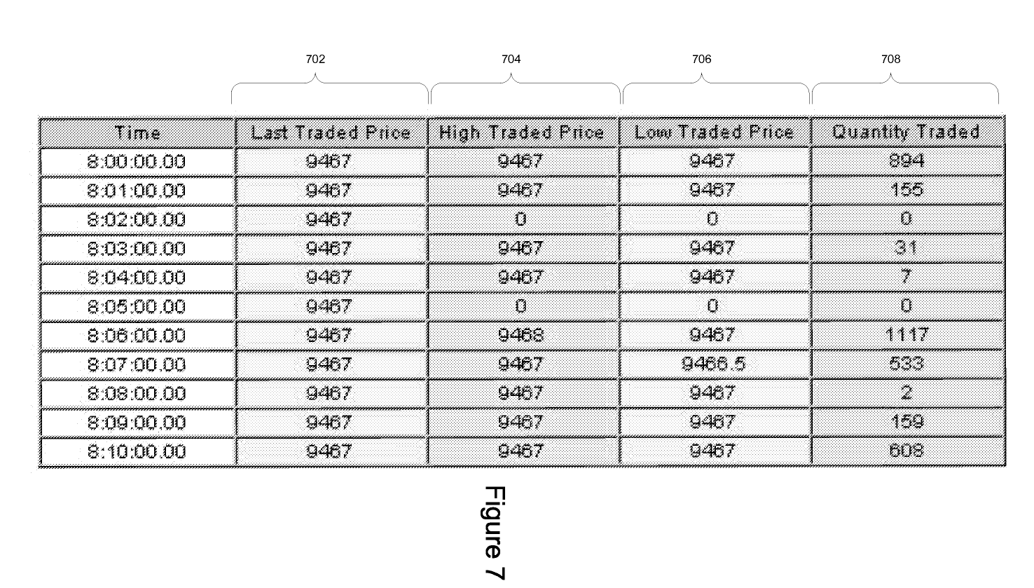

The formatted market information may be outputted in either HTML or CVS format (or other usable format for importation into a third-party viewer). In one example in accordance with aspects of the invention, the formatted market information comprises HTML (hypertext markup language) configured to direct a HTML-complaint viewer (e.g., a Microsoft Internet Explorer web browser, or Mozilla Internet browser) to render the plurality of bid/ask market information in a plurality of levels. Referring to FIG. 3, FIG. 4, FIG. 5, FIG. 6, and FIG. 7, these figures illustrate numerous embodiments of the formatted market information displayed on graphical user interfaces in accordance with aspects of the invention.

In FIG. 3, in response to a query type of “best limit” for historical market information of a particular financial instrument, an application server 110 may format the relevant data and send formatted market information. The formatted market information may render as depicted in FIG. 3 on a graphical user interface on a user computer 122, 124, 126. The formatted market information includes bid prices, bid quantities, bid order quantities, ask prices, ask quantities, and ask order quantities depicted in a 5-level deep book format. The best bid information 302 is formatted besides the second-best bid information 304, which is formatted besides the third-best bid information 306, and so on. In the example of FIG. 3, the formatted market information is shown in a 5-level deep format. However, one skilled in the art will appreciate that any number of levels may be shown depending on the depth of market data retrieved from the data server 102.

Furthermore, the best ask information 308 is depicted alongside the bid information. Likewise, the second-best ask information, third-best ask information, etc. (not fully shown) are depicted alongside the best ask information 310. Moreover, for viewing ease the levels of the bid/ask information may be rendered in different colors and/or different gradients (i.e., color intensity). For example, the bid information 302 in the first level may be rendered with a blue background with a light intensity (e.g., shading). Meanwhile, the bid information 304 in the second level may be rendered with the same blue background, but with a slightly darker intensity. The third level may also be rendered with the same blue background, but with an even darker intensity. Likewise, the ask information 308 in the first level may be rendered with a green background with a light intensity (e.g., shading). Subsequent levels of ask information may be similarly rendered with a green background, but with a gradually darker intensity.

In FIG. 4, in response to a query type of “best limits and implied” for historical market information of a particular financial instrument, an application server 110 may format the relevant data and send formatted market information. The formatted market information may render as depicted in FIG. 4 on a graphical user interface on a user computer 122, 124, 126. The formatted market information includes bid prices, bid quantities, ask prices, and ask quantities as depicted in a 2-level deep book format 402, 404. One skilled in the art will appreciate after review of the entirety disclosed herein that by itself implied bid/ask information relates to the spread and not the actual traded price. However, at least one advantage of the formatted market information displayed in FIG. 4 is the enhanced analysis provided to a viewer of the graphical user interface.

In FIG. 5, in response to a query type of “best price and limit” for historical market information of a particular financial instrument, an application server 110 may format the relevant data and send formatted market information. The formatted market information may render as depicted in FIG. 5 on a graphical user interface on a user computer 122, 124, 126. The formatted market information includes bid prices, bid quantities, bid order quantities, ask prices, ask quantities, ask order quantities, trade price, and trade quantity depicted in a 2-level deep book format 502, 504.

In FIG. 6, in response to a query type of “liquidity” for historical market information of a particular financial instrument, an application server 110 may calculate a plurality of data, format the relevant data, and send formatted market information. The formatted market information may render as depicted in FIG. 6 on a graphical user interface on a user computer 122, 124, 126. The formatted market information may include spread information 602, bid difference information 604, ask difference information (not fully shown in FIG. 6), and other useful information associated with the financial instrument in a multi-level deep book format.

In the example of FIG. 6, the “TWA Spread_Diff_{—}1” column corresponds to the time weighted average of the best limit ask price minus the best limit bid price. Likewise, the “TWA Spread_Diff_{—}2” column corresponds to the time weighted average of the 2^{nd} best limit ask price minus the 2^{nd} best limit bid price. The “TWA Bid_Diff_{—}12” column corresponds to the time weighted average of the best limit bid price minus the 2nd best limit bid price. The “TWA Ask_Diff12” column (not shown) corresponds to the time weighted average of the 2nd best limit ask price minus the best limit ask price. The “TWA Bid_Qty_{—}1” column (not shown) corresponds to the time weighted average of the best limit bid quantity. The “TWA Ask_Qty_{—}1” column (not shown) corresponds to the time weighted average of the best limit ask quantity. In this example, the time weighted averages were taken at 1-minute intervals. However, one skilled in the art will appreciate that any reasonable predetermined interval may be used in calculating and formatting the historical market data. One skilled in the art will appreciate that some amount of processing is performed to calculate the spread information 602, bid difference information 604, ask difference information, and other useful information described herein.

In FIG. 7, in response to a query type of “trade analytics” for historical market information of a particular financial instrument, an application server 110 may calculate a plurality of data, format the relevant data, and send formatted market information. The formatted market information may render as depicted in FIG. 7 on a graphical user interface on a user computer 122, 124, 126. The formatted market information may include the last traded price 702, highest traded price 704, lowest traded price 706, quantity traded 708, and other useful information associated with the financial instrument over a regular 1-minute interval. In this example, the values were calculated using a 1-minute interval, however, one skilled in the art will appreciate that any reasonable interval may be used in calculating and formatting the historical market data. In one example, relevant portions of data in market data message types M5 and M6 may be used and processed to calculate the formatted market information displayed in FIG. 7.

In addition, other graphical user interface displaying formatted market in accordance with aspects of the invention are contemplated by the disclosure. For example, in response to a query type of “time and sales” for historical market information, an application server 110 may process the relevant data and calculate the time of a price change, the current price at that time, and the accumulate quantity of orders at that price. A simple screenshot of a market data graphical display taken at different times during a trading day falls short of the graphical user interface contemplated by the aforementioned processing. These calculations and other combination of calculations will be apparent to one skilled in the art after a review of the entire intrinsic record.

Various embodiments have been described and illustrated. However, the description and illustrations are by way of example only. Many more embodiments and implementations are possible within the scope of this invention and will be apparent to those of ordinary skill in the art. For example, one of skill in the art will appreciate that the architecture of FIG. 1 may be implemented in a thin-client or thick-client implementation. As such, user computers 122, 124, 126 and application server 110 may be implemented in a single computing device where a thick-client implementation is desired. In the case of a thin-client implementation, a thin-client viewer program (e.g., a web browser) at a user computer 122, 124, 126 may be used to interact with and access formatted market information sent from a remote application server 110 configured to perform a bulk of the calculations and/or processing. The various embodiments are not limited to the described environments, and can be applied to a wide variety of activities.

It is intended in the appended claims to cover all such changes and modifications which fall within the true spirit and scope of the invention. Therefore, the invention is not limited to the specific details, representative embodiments, and illustrated examples in this description. Accordingly, the invention is not to be restricted except in light as necessitated by the accompanying claims and their equivalents.

What is claimed is:

1. A system for providing historical market data in a plurality of levels, the system comprising:
a data server storing market data files;
an application server configured to communicate formatted market information in response to a query received at the application server, the formatted market information comprising data corresponding to the market data files, and the formatted market information including a plurality of levels for a financial instrument identifier corresponding to the query; and
a plurality of user computers in communication with the application server, each of the plurality of user computers including a input component for receiving parameters relating to the query and a graphical user interface for rendering the formatted market information, the parameters relating to the query including a historical timeframe and the financial instrument identifier.

2. The system of claim 1, comprising:
at least one cache server in communication with the data server, the application server in communication with the at least one cache server, the at least one cache server configured to communicate the data corresponding to the market data files in response to receiving a request.

3. The system of claim 2, where the market data files are retrievable according to trading day in a memory of the data server, and the at least one cache server is configured to store data corresponding to the market data files received from the data server.

4. The system of claim 2, where the data corresponding to the market data files is stored in an uncompressed form in memory of the at least one cache server, and the market data files are stored in a compressed form in memory of the data server.

5. The system of claim 1, where the application server is configured to process the query to generate a request for data corresponding to a market data file.

6. The system of claim 1, where the financial instrument identifier comprises at least one of: futures, contracts, options, bonds, securities commodities, annuities, and currencies.

7. The system of claim 1, where the historical timeframe includes a date and a time range.

8. The system of claim 7, where the formatted market information comprises a plurality of bid prices, bid quantities, ask prices, and ask quantities for the financial instrument identifier at a particular time occurring during the time range.

9. The system of claim 8, where the formatted market information comprises trade price and trade quantity for the financial instrument identifier.

10. The system of claim 1, where the formatted market information comprises a plurality of bid prices, bid quantities, bid order quantities, ask prices, ask quantities, and ask order quantities for the financial instrument identifier at a particular time occurring during the historical timeframe.

11. The system of claim 1, where the application server is configured to calculate a plurality of spread information, bid difference information, and ask difference information associated with the financial instrument identifier based on the data corresponding to the market data files to output formatted market information.

12. A computing device, comprising:
a memory for storing at least computer-readable instructions;
an input component configured to receive a query;
an output component configured to output formatted market information; and
a processor configured to execute the computer-readable instructions to perform a method comprising:
receiving the query through the input component, the query comprising at least a historical date, a time range, and a financial instrument identifier;
processing the query to generate a request for data corresponding to a market data file;
sending the request for the data;
receiving the data corresponding to a market data file in response to the request;
formatting relevant portions of the data according to a query type to generate formatted market information, the formatted market information comprising a plurality of bid prices, bid quantities, ask prices, and ask quantities for the financial instrument identifier at a particular time occurring during the time range on the historical date; and
sending the formatted market information to the output component.

13. The device of claim 12, where the query type is one of: best limit, best implied, best price, best price and limit, best limit and implied, trade, and time and sales.

14. The device of claim 12, where the formatted market information comprises HTML configured to direct a HTML-compliant viewer to render:
a first level of the plurality of bid prices and bid quantities in a first background color with a first gradient;
a second level of the plurality of bid prices and bid quantities in a first background color with a second gradient;
a third level of the plurality of bid prices and bid quantities in a first background color with a third gradient;
a first level of the plurality of ask prices and ask quantities in a second background color with a first gradient;
a second level of the plurality of ask prices and ask quantities in a second background color with a second gradient; and
a third level of the plurality of ask prices and ask quantities in a second background color with a third gradient.

15. The device of claim 12, where the input component and output component are located in a network communications unit.

16. The device of claim 12, where the input component comprises a keypad, and the output component comprises a viewable display screen.

17. A computing device, comprising:
a memory for storing at least computer-readable instructions;
an input component configured to receive a query;
an output component configured to output formatted market information; and
a processor configured to execute the computer-readable instructions to perform a method comprising:
receiving the query through the input component, the query comprising at least a historical timeframe and a financial instrument identifier;
processing the query to generate a request for data corresponding to a market data file;
sending the request for the data;
receiving the data corresponding to a market data file in response to the request;
calculating a plurality of spread information, bid difference information, and ask difference information associated with the financial instrument identifier using the relevant portions of the data;
formatting the plurality of spread information, bid difference information, and ask difference information to generate formatted market information, the formatted market information comprising the plurality of spread information, bid difference information, and ask difference information for the financial instrument identifier at a particular time occurring during the historical timeframe; and
sending the formatted market information to the output component.

18. The device of claim 17, where the input component and output component are located in a network communications unit.

19. The device of claim 17, where the input component comprises a keypad, and the output component comprises a viewable display screen.

20. A method of providing a plurality of levels of historical market data, the method comprising:
receiving a query, where the query comprises at least a query type, a historical timeframe, and a financial instrument identifier;
processing the query to generate a request for historical market data;
sending a request for historical market data, where the historical market data corresponds to the query;
receiving the historical market data in response to the request;
formatting relevant portions of the historical market data according to a query type to generate formatted market information, the formatted market information comprising a plurality of bid prices, bid quantities, ask prices, and ask quantities for the financial instrument identifier at a particular time occurring during the historical timeframe; and
sending the formatted market information.

21. The method of claim 20, where sending the formatted market information causes a graphical user interface to render:
a first level of the plurality of bid prices and bid quantities in a first background color with a first gradient;
a second level of the plurality of bid prices and bid quantities in a first background color with a second gradient;
a third level of the plurality of bid prices and bid quantities in a first background color with a third gradient;
a first level of the plurality of ask prices and ask quantities in a second background color with a first gradient;
a second level of the plurality of ask prices and ask quantities in a second background color with a second gradient; and
a third level of the plurality of ask prices and ask quantities in a second background color with a third gradient.

22. The method of claim 20, where sending the formatted market information includes sending the formatted market information over a network to a remote computing device.

23. The method of claim 20, where the query type is one of: best limit, best implied, best price, best price and limit, best limit and implied, trade, and time and sales.

24. A method of providing a plurality of levels of historical market data, the method comprising:
receiving a query, where the query comprises at least a query type, a historical timeframe, and a financial instrument identifier;
processing the query to generate a request for historical market data;
sending a request for historical market data, where the historical market data corresponds to the query;
receiving the historical market data in response to the request;
calculating a plurality of spread information, bid difference information, and ask difference information associated with the financial instrument identifier over a predetermined time interval using the relevant portions of the historical market data;
formatting the plurality of spread information, bid difference information, and ask difference information to generate formatted market information, the formatted market information comprising the plurality of spread information, bid difference information, and ask difference information for the financial instrument identifier at a particular time occurring during the historical timeframe; and
sending the formatted market information.

25. A computer-readable medium comprising computer-executable instructions for performing the method of claim 20.

26. A computer-readable medium comprising computer-executable instructions for performing the method of claim 24.
